(19) United States
(12) Patent Application Publication
(10) Pub. No.: US 2002/0060825 A1
(43) Pub. Date: May 23, 2002

(54) Passive optical transceivers

(76) Inventors: Adam Mark Weigold, Unley (AU); Peter Graham Foster, Belair (AU)

Correspondence Address: NIXON & VANDERHYE P.C., 1100 North Glebe Road, 8th Floor, Arlington, VA, 22201-4714, US

(21) Appl. No.: 09/989,103

(22) Filed: Nov. 21, 2001

Related U.S. Application Data
(60) Provisional application No. 60/252,454, filed on Nov. 22, 2000.

(51) Int. Cl. H04B 10/00

(52) U.S. Cl. 359/152; 359/168

(57) ABSTRACT

A passive optical transceiver for receiving a first optical signal stream and transmitting a second optical signal stream, including a photodetector for detecting a first portion of the first stream, and an optical modulator for modulating a second portion of the first stream to provide the second stream wherein said streams are colinear with said photodetector and said modulator.

### FIELD OF THE INVENTION

The present invention relates to passive optical transceivers and, in particular a transceiver adapted to receive optical signals from external sources, decode data from the signals, and encode other data onto the signals for transmission.

### BACKGROUND OF THE INVENTION

Passive optical networks (PONs) provide cost-efficient delivery of broadband data services to homes. The term ‘passive’ usually refers to the absence of powered, active elements between the transmitter and the receiver, but may also refer to bidirectional loop-back networks in which the transceiver in the home does not contain a light source. The transceiver transmits upstream data by encoding it onto the light sent downstream from a central office or exchange. However, these devices generally use either (i) separate input and output ports, requiring separate upstream and downstream optical fibers, or (ii) the inclusion of complex and costly optical components, such as optical circulators and isolators. It is desired, therefore, to provide a single port passive optical transceiver, or at least a useful alternative.

### SUMMARY OF THE INVENTION

In accordance with the present invention there is provided a passive optical transceiver for receiving a first optical signal stream and transmitting a second optical signal stream, including:

a photodetector for detecting a first portion of said first stream; and

an optical modulator for modulating a second portion of said first stream to provide said second stream;

wherein said streams are colinear with said photodetector and said modulator.

The present invention also provides an optical transceiver including:

an input/output port for receiving a first optical signal stream and transmitting a second optical signal stream;

a photodetector;

an optical modulator for passing said streams and for modulating said second stream in response to a modulation signal; and

a reflector for passing said first stream for detection by said photodetector and for partially reflecting said first stream to said optical modulator to provide said second stream.

The present invention also provides a passive optical transceiver, including an optical modulator, a partially reflective mirror, and a photodetector, said mirror, modulator and photodetector arranged to be substantially coaxial with the axis of light propagation through said transceiver, and configured so that light entering the transceiver passes through the modulator to the mirror, where a portion of said light is transmitted through the mirror to the photodetector, and another portion of said light is reflected by the mirror, is modulated by the modulator, and is transmitted from said transceiver.

The present invention also provides a method of encoding second data onto an optical stream encoded with first data, including:

receiving said optical stream encoded by modulating its intensity between a first non-zero intensity and a second non-zero intensity on the basis of said first data;

and

encoding said second data onto said optical stream by further modulating said optical stream by attenuating its intensity between a first attenuation value and a second attenuation value, said attenuation values chosen so that their ratio is different from the ratio of said first and second intensities.

### BRIEF DESCRIPTION OF THE DRAWINGS

Preferred embodiments of the present invention are hereinafter described, by way of example only, with reference to the accompanying drawings, wherein:

FIG. 1 is a schematic diagram of a first preferred embodiment of a passive optical transceiver;

FIG. 2 is a schematic diagram of a second preferred embodiment of a passive optical transceiver;

FIG. 3 is a schematic representation of the optical signals processed by the passive optical transceiver of the embodiments;

FIGS. 4A to 4C are schematic diagrams of a third preferred embodiment of a passive optical transceiver; and

FIG. 5 is a schematic diagram of a fourth preferred embodiment of a passive optical transceiver, and illustrating the polarisation changes in the upstream and downstream signals.

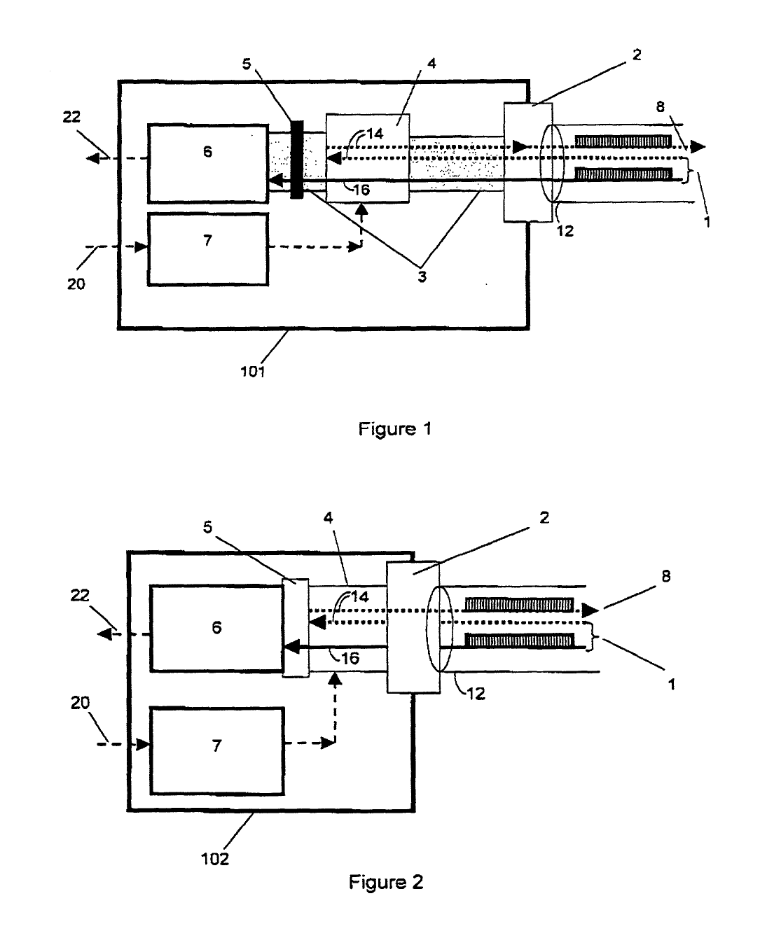

### DETAIL DESCRIPTION OF PREFERRED EMBODIMENTS OF THE INVENTION

A passive optical transceiver 101, 102, 103 and 104, as shown in the Figures, includes a single optical port 2, an optical modulator 4, a partially reflective mirror 5, and a photodetector 6, arranged in a colinear or coaxial manner. The transceiver 101, 102, 103 and 104 is passive in the sense that it transmits optical signals using light received from an external source.

Downstream optical data signals I transported along an optical fiber 12 enter the transceiver 101 through the input/output optical port 2, and are transported along an optical pathway 3 through the modulator 4 to the partially reflective mirror 5. Because the mirror 5 is partially reflective, only a portion 14 of the light falling on the mirror 5 is reflected, and another portion 16 of the light is transmitted through the mirror 5 to the photodetector 6. The photodetector 6 converts the information encoded into the light as variations in intensity into electrical output signals 22. These signals 22 are subsequently processed by external circuitry.

Upstream data to be transmitted by the transceiver 101 is supplied to the transceiver 101 as electrical input signals 20. A driver circuit 7 converts this electrical input data 20 into an electrical signal suitable for driving the modulator 4. The portion 14 of the downstream light that was reflected by the partially reflective mirror 5 re-enters the modulator 4, which modulates the intensity of the reflected light 14 on the basis of the input signals 20 to encode the information from the electrical input signals 20 as an upstream optical data signal 8 which is transmitted from the transceiver 101 via the input/output port 2 into the optical fiber connected to the port 2.

In a second transceiver 102, the optical pathways 3 are eliminated so that the modulator 4, the mirror 5 and the photo-detector 6 are close-coupled to each other, as shown in FIG. 2. This reduces optical losses and round-trip transit time, and simplifies construction.

The photodetector 6 is a high-speed InGaAs photodiode with sub-nanosecond rise and fall times, but photodiodes fabricated from other semiconducting materials could alternatively be used, as is known to those skilled in the art.

The modulator 4 is a lithium niobate Mach-Zehnder interferometer, but could alternatively be a Pockels cell, an optic fiber modulator, or another kind of modulator, such as those based on polymer, silicon, electro-refraction, semiconductor multi-quantum-wells, electro-absorption, optical amplifiers, or micro-electro-mechanical systems (MEMS), for example. However, the modulator 4 operates in a single direction only (i.e., the upstream direction), as described below, so that the optical signals passing downstream through the modulator data are not modulated.

As with dual port transceivers, the appropriate choice of components enables the single port in-line transceiver 101, 102 to be configured for single wavelength time-division multiplexing (TDM) or wavelength division multiplexing (WDM) architectures. In the WDM configuration, the mirror is ≈100% transmitting at the downstream wavelength and =100% reflecting at the upstream wavelength. For example, a standard di-electric mirror could be used to achieve 99.98% transmission at 1310±50 nm, and 99.98% reflectivity at 1550±50 nm. In the TDM configuration, the downstream and upstream signals are allotted different time slots, and the partially reflective mirror 5 can be replaced with a device capable of a time-varying broadband reflectance and transmittance, such as a MEMS device that acts as a mirror that can be switched on and off. Examples of such devices include a micromachined actuator with a mirror that is inserted into and withdrawn from the optical path, and a mechanical anti-reflection switch, as described in U.S. Pat. No. 5,923,798 and 5,949,571.

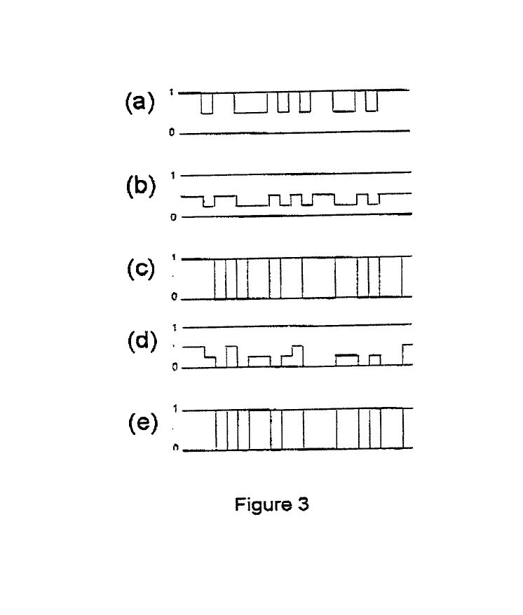

Alternatively, the upstream signal can be encoded onto the downstream data by amplitude division multiplexing (ADM). This method enables the transceiver 101, 102 to possess the advantages of both TDM and WDM architectures without suffering the associated disadvantages. In other words, a single wavelength ADM architecture allows for close channel spacing and broadband wavelength compatibility without sacrificing transmission speed or requiring complex clock synchronization. Moreover, the components required for single-wavelength ADM architectures are relatively cheap and readily available. FIG. 3 shows an example of optical signals processed by the transceiver 102, 103. The downstream data signal 1 is transmitted with the “on” state being at full power “1” and the “off” state at half power “½”, as shown in FIG. 3(a). The mirror 5 allows a portion of the downstream data to transmit through to the photo-detector 6 to form the “receive” signal, as shown in FIG. 3(b). For the purposes of illustration, the mirror is assumed to be a 50% optical coupler. The photo-detector 6 circuit discriminates a “1” whenever the receive signal is greater than ¼ amplitude level, The remaining downstream signal is reflected back through the modulator 4 to be encoded as the upstream or “send” signal 8. The modulator 4 superimposes its upstream data (as shown in FIG. 3(c)) onto the reflected part of the input signal (FIG. 3(b)) by passing the reflected signal directly to the input/output port 2 when the upstream data is a “1”, and blocks it when the upstream signal is “0”. This results in the transmitted optical signal shown in FIG. 3(d). The receiver at the other end of the bi-directional link sees the upstream data signal from the transceiver and discriminates a “1” whenever the returned power is greater or equal to ¼ amplitude level.

For an ADM transceiver to work in practice, it is prudent to use more sophisticated ADM methods with different coupling optics. For example, a reduced on/off variation is used for the downstream signal (e.g., on state =100%, off state =80%). This requires a more sensitive photodetector for the downstream signal, but improves the signal-to-noise ratio of the upstream signal 8. It also has the advantage of minimizing Rayleigh noise that is often observed in high-speed single fiber links. Rayleigh noise is caused by interference of bi-directional signals with Rayleigh backscattered light. The small downstream signal is constructed to effectively be a “dither” modulation signal that reduces interference effects. Dither signals reduce such noise and are electronically removed at the detector end. When the dither downstream signal operates at a different modulation frequency than the larger upstream modulation, Rayleigh noise is reduced by several orders of magnitude. Hence the downstream signal operates as both a dither signal to reduce noise and a carrier of data. Instead of the dither signal being removed at the photodetector, it is measured and converted into an electronic data stream.

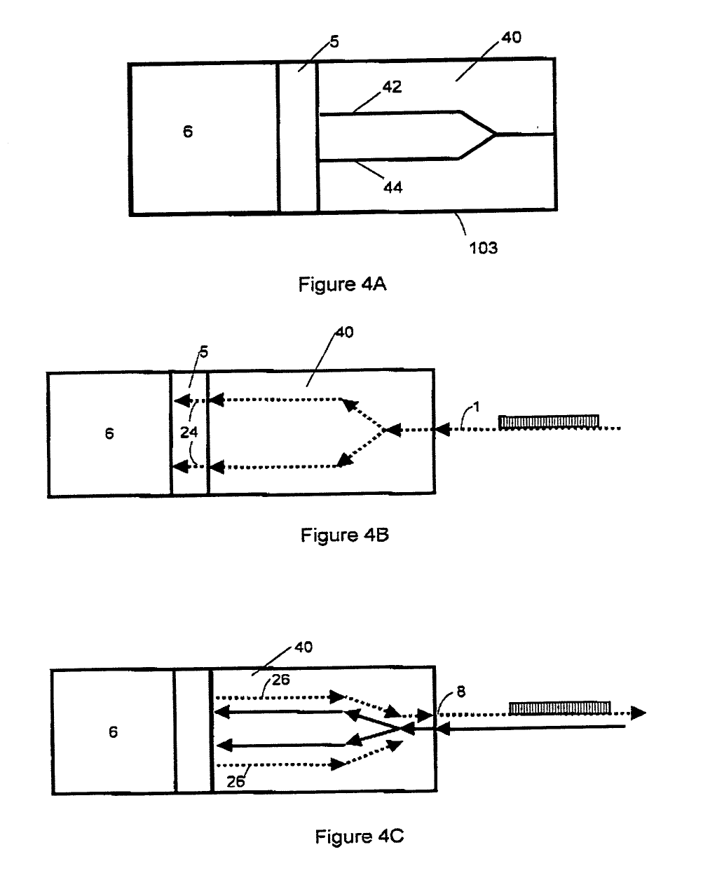

In a third transceiver 103, as shown in FIGS. 4A to 4C, a modulator 40 is used that is a type of Michelson modulator, as it utilizes a reflecting Michelson interferometer arrangement rather than a conventional Mach-Zehnder interferometer arrangement. The partially reflecting mirror 5 acts both as a filter for the downstream signal to the photodetector 6 and as a critical path component for the operation of the Michelson modulator 40. The Michelson modulator 40 is coupled to the mirror 5 and photodetector 6, as shown in FIG. 4A, to form the single-port in-line Michelson transceiver 103. For clarity, components such as the input/output port 2, optical fiber, and driver circuit 7 have been omitted from FIGS. 4A to 4C.

As shown in FIG. 4B, the downstream data signal 1 containing both the downstream data and upstream carrier signal enters the modulator 40 and the incoming optical power is divided between the two Michelson arms 42 and 44 of the transceiver 103. The modulator arms 42, 44 are fabricated from a non-linear optical material such as lithium niobate that can function as a phase or amplitude modulator by the electro-optic effect. Each arm of the modulator 4 produces a phase change in the transmitted signals. One arm is used to produce a positive phase change, whilst the other arm is used to produce a negative phase change. Alternatively, only one arm may be used to phase-modulate the optical signal. The two resultant downstream signals 24 pass through the mirror 5 and arrive at the photodetector 6 spatially separated and with different phases. At the mirror 5, the two downstream signals 24 are transmitted while the two upstream components 26 are reflected back through the modulator arms 42 and 44, As the two downstream signals 24 arrive at the photodetector 6 spatially separated, there is no phase-induced interference between them, even though a phase change has been imparted on them. Hence the transmitted downstream signal can be measured by one or two photodetectors 6, even when the modulator 4 is being operated to encode the upstream signal, because the photodetector 6 is insensitive to the phases of the optical signals. As shown in FIG. 4C, the two reflected upstream signals 26 recombine at the junction of the arms 42 and 44. The phase difference between the two reflected upstream signals 26 causes destructive interference at the junction of the arms, 42, 44 and this phase difference may be adjusted to modulate the intensity of the recombined signal 8. Hence amplitude modulation of the upstream signal 8 can be achieved without affecting the transmission of the downstream signal 24 to the detector. With the appropriate choices of drive signal, mirror characteristics or additional components, the Michelson modulator transceiver 103 can be operated with ADM, TDM or WDM, as discussed above. The Michelson modulator 40 is insensitive to polarisation, and consequently can be used with all conventional fiber infrastructures.

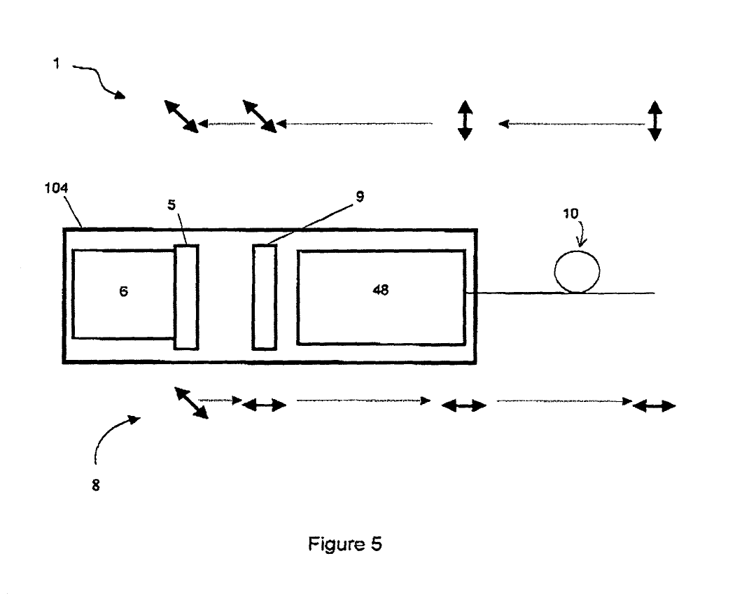

A fourth in-line multi-component transceiver 104 uses a polarisation-dependent electro-optic modulator 48, as shown in FIG. 5. In typical fiber-optic networks, linearly polarised light from active sources loses much of its preferred polarisation state after travelling through a long enough distance of conventional optical fiber. This effect, known as polarisation dispersion loss, results in optical output that is significantly less polarised than the input light, with a smaller degree of preferred orientation. In conventional optical networks, this may be undesirable because it typically necessitates the use of expensive polarisation-insensitive components for passive switching and routing operations. Efficient modulation of unpolarised light requires polarisation-insensitive modulators (such as a Mach-Zehnder or Michelson device) instead of cheaper polarisation-sensitive modulators with a single optical pathway (such as a Pockels cell device). If a polarisation-sensitive device is used with unpolarised light, only a small portion of the light is actually modulated—that light which corresponds to the polarisation requirements of the modulator. However, significant advances have been recently made in the development of polarisation maintaining fibers (also known as polarisation preserving fibers). These fibers allow transmission of linearly polarised light over several kilometers, or even tens of kilometers, without significant depolarisation. An in-line transceiver 104 can be constructed using polarising element(s) and a polarisation-dependent modulator 48 so that efficient operation is possible using polarisation maintaining fiber as the transmission medium. This device again possesses the essential characteristic of the other transceivers 101, 102, and 103 discussed above—that the downstream data is not affected by the upstream data signal.

In the fourth transceiver 104, the downstream signal is vertically polarised and maintains this polarisation during its transmission through the polarisation maintaining fiber 10, as shown in FIG. 5. Downstream light enters the electro-optic modulator 48, which is orientated so that it only modulates light with horizontal polarisation. Consequently, the downstream signal passes through the modulator 48 unaffected until it arrives at the polarisation element 9 which rotates the vertical polarisation by a quarter wave or 45° of polarisation. The “diagonally” polarised light travels through to the mirror 5, where a portion is transmitted through to the photodetector 6 where the downstream signal is then detected. The mirror 5 is either a broadband mirror suitable for amplitude multiplexing, or a wavelength-dependent mirror suitable for wavelength multiplexing the signals, depending upon configuration. The upstream portion of the diagonally polarised signal is reflected at the mirror 5 and passes though the polarising element 9 for the second time. The polarising element 9 rotates the polarisation vector of the circularly or diagonally polarised light a further 45° to produce horizontally polarised light. The horizontally polarised light is then selectively modulated with the upstream data by the electro-optic modulator 48. The upstream data then travels back through the optical fiber without loss of polarisation.

A number of variations can be made to the four embodiments described above to provide additional embodiments. For example, in an alternative fifth embodiment, the modulator 4 is a standard modulator, insensitive to the direction of light propagation, but the downstream and upstream optical signals are divided by a time-division multiplexing (TDM) scheme, whereby particular time slots are allocated to downstream data, and the remaining time slots are allocated to upstream data. By turning the modulator 4 off during the downstream time slots, the downstream data is not modulated as it passes through tile modulator 4.

In a sixth embodiment, the upstream and downstream signals are discriminated by using a switchable reflection/transmission device, as described above, in a free-space optical path between the modulator 4 and the photodetector 6.

In a seventh embodiment, the downstream light is encoded with the upstream data by the modulator before reaching the photodetector, but the upstream data is electronically removed from the composite optical signals received in the photodetector 6.

In an eighth embodiment, the mirror 5 is removed and the transceiver is made transparent by using a partially transparent photodetector 6. A partially transparent photodetector device may be based on electro-absorption or similar technology. This configuration requires separate input and output fibers, located on both ends of the partially transparent photodetector device, and is used in ring networks.

In a ninth embodiment, a partially transparent photodetector device is placed in front of, instead of behind, the modulator 4. This is the reverse of the in-line designs presented above.

The principal advantages of the passive in-line optical transceivers described herein over prior art transceivers are a reduction in components, simpler design, and intrinsic single port operation. These transceivers can be constructed to work with WDM, TDM and ADM multiplexing architectures. Furthermore, the use of ADM with an in-line transceiver provides single wavelength operation without sacrificing speed and design simplicity when compared to single-wavelength TDM architectures. The principal applications for these passive in-line optical transceivers include local access networks, local area networks, and possibly larger metropolitan networks. The potential for high-volume, low-cost manufacturing also enables a good compatibility with fiber-to-the-desktop architectures.

Moreover, there is scope for the transceiver to be applied to fast bus interfaces between components within computer systems (eg interconnects between central processing units and peripheral processor chips).

Many modifications will be apparent to those skilled in the art without departing from the scope of the present invention as herein described with reference to the accompanying drawings.

1. A passive optical transceiver for receiving a first optical signal stream and transmitting a second optical signal stream, including:
a photodetector for detecting a first portion of said first stream; and
an optical modulator for modulating a second portion of said first stream to provide said second stream;
wherein said streams are colinear with said photodetector and said modulator.

2. A passive optical transceiver, as claimed in claim 1, including a port for receiving said first optical signal stream and transmitting said second optical signal stream.

3. A passive optical transceiver, as claimed in claim 1 or 2, including means for reflecting a portion of said first optical signal stream to said optical modulator to provide said second stream.

4. A passive optical transceiver, as claimed in claim 3, wherein said reflected portion is a constant part of the power of said first optical signal stream.

5. A passive optical transceiver, as claimed in claim 3, wherein said first portion of said first signal stream has a first wavelength and said second portion of said first signal stream has a second wavelength, and said reflecting means operates on the basis of wavelength division.

6. A passive optical transceiver, as claimed in claim 3, wherein said reflecting means is switchable to reflect a portion of said first stream on the basis of time division.

7. A passive optical transceiver, as claimed in claim 1, wherein said modulator is switchable to modulate a portion of said first stream on the basis of time division.

8. A passive optical transceiver, as claimed in any one of claim 3, wherein said first signal passes through said modulator in a first direction, and the reflected portion of said first signal passes through said modulator in a second direction, and said modulator passes said first signal in said first direction substantially unmodulated.

9. A passive optical transceiver, as claimed in claim 8, wherein said modulator includes arms for splitting said first optical signal stream into split signal streams, phase shifting at least one of the split signal streams, independently transporting the split signal streams for detection at spatially distinct locations, and detecting said first optical signal stream substantially independent of said phase shifting.

10. A passive optical transceiver, as claimed in claim 9, wherein said split signal streams are detected at spatially distinct locations of said photodetector.

11. A passive optical transceiver, as claimed in claim 9, wherein each of said split signal streams is detected by a respective photodetector.

12. A passive optical transceiver, as claimed in any one of claims 9 to 11, wherein said modulator includes a first arm for inducing a positive phase shift, and a second arm for inducing a negative phase shift.

13. A passive optical transceiver, as claimed in claim 8, wherein said modulator operates on the basis of a difference in polarisation between said first optical signal stream and said reflected portion.

14. A passive optical transceiver, as claimed in claim 13, wherein said modulator is an electro-optic modulator, and said transceiver includes a polarisation element located between said modulator and said reflecting means, said polarisation element rotating the polarisation vector of said first optical signal stream and said reflected portion by 45°.

15. A passive optical transceiver, as claimed in claim 1, wherein said modulating includes overmodulating a second signal onto said second portion of said first optical signal to provide said second optical signal.

16. A passive optical transceiver, as claimed in claim 15, wherein said first optical signal includes first data encoded by modulation between a first non-zero intensity and a second non-zero intensity, and said overmodulation includes attenuating the intensity of said second portion between a first attenuation value and a second attenuation value, said attenuation values chosen so that their ratio is different from the ratio of said first and second intensities.

17. A passive optical transceiver, as claimed in claim 16, wherein said second non-zero intensity is a substantial fraction of said first non-zero intensity, and said second attenuation value is substantially complete attenuation.

18. A passive optical transceiver, as claimed in any one of claims 15 to 17, wherein the frequency of said overmodulation is substantially greater than the frequency of said modulation of said first data.

19. A passive optical transceiver, as claimed in claim 18, wherein said frequency of said overmodulation is chosen to effect dither modulation to reduce interference effects in said second optical signal stream.

20. A passive optical transceiver, as claimed in any one of claim 1, wherein said modulator modulates said first optical signal stream, and said transceiver includes means for removing the modulation applied to said first optical signal from a corresponding electronic signal generated by said photodetector.

21. A passive optical transceiver, as claimed in claim 1, wherein said photodetector is partially transparent and allows said second portion of said first optical signal stream to pass through said photodetector to provide said second stream.

22. An optical transceiver including:
an input/output port for receiving a first optical signal stream and transmitting a second optical signal stream;
a photodetector;
an optical modulator for passing said streams and for modulating said second stream in response to a nodulation signal; and
a reflector for passing said first stream for detection by said photodetector and for partially reflecting said first stream to said optical modulator to provide said second stream.

23. An optical transceiver as claimed in claim 22, wherein said first stream is in one direction and said second stream is in an opposite direction.

24. A passive optical transceiver, including an optical modulator, a partially reflective mirror, and a photodetector, said mirror, modulator and photodetector arranged to be substantially coaxial with the axis of light propagation through said transceiver, and configured so that light entering the transceiver passes through the modulator to the mirror, where a portion of said light is transmitted through the mirror to the photodetector, and another portion of said light is reflected by the mirror, is modulated by the modulator, and is transmitted from said transceiver.

25. A passive optical transceiver as claimed in claim 24, wherein said mirror, modulator and photodetector are substantially coaxial with the axis of light propagation through said transceiver.

26. A method of encoding second data onto an optical stream encoded with first data, including:
receiving said optical stream encoded by modulating its intensity between a first non-zero intensity and a second non-zero intensity on the basis of said first data; and
encoding said second data onto said optical stream by further modulating said optical stream by attenuating its intensity between a first attenuation value and a second attenuation value, said attenuation values chosen so that their ratio is different from the ratio of said first and second intensities.

27. An optical network including at least one optical transceiver as claimed in any one of claims 1 to 25.

28. A point to point optical network having passive optical transceivers, as claimed in any one of claims 1 to 25, connected to active optical transceivers in a central hub.

29. A point to point optical network having active optical transceivers connected to passive optical transceivers as claimed in any one of claims 1 to 25, wherein said passive optical transceivers are in a central hub.

30. A computer bus architecture having at least one optical transceiver as claimed in any one of claims 1 to 25.

31. A computer bus architecture with an optical network as claimed in any one of claims 27 to 29.
